(19) United States
(12) Patent Application Publication
(10) Pub. No.: US 2018/0110678 A1
(43) Pub. Date: Apr. 26, 2018

(54) Apparatuses for Dispensing Medicaments and Uses Thereof

(71) Applicant: KWS Packaging, LLC, Winston Salem, NC (US)

(72) Inventors: Marybeth Watson Terry, Winston Salem, NC (US); Brian William Dufour, Kernersville, NC (US); Cecil Manning Davis, Winston Salem, NC (US)

(21) Appl. No.: 15/783,021

(22) Filed: Oct. 13, 2017

Related U.S. Application Data
(60) Provisional application No. 62/408,213, filed on Oct. 14, 2016.

(51) Int. Cl. A61J 1/03; B65D 83/04

(52) U.S. Cl. CPC A61J 1/03; B65D 83/0481; B65D 83/0409

(57) ABSTRACT

The present disclosure generally provides apparatuses useful for containing and dispensing pills or other medicaments, particularly in a health care context, as well as methods of using such apparatuses and systems incorporating such apparatuses.

### CROSS-REFERENCE TO RELATED APPLICATIONS

The present application claims the benefit of priority of U.S. Provisional Application No. 62/408,213, filed Oct. 14, 2017, which is hereby incorporated by reference as though set forth herein in its entirety.

### TECHNICAL FIELD

The present disclosure generally provides apparatuses useful for containing and dispensing pills or other medicaments, particularly in a health care context, as well as methods of using such apparatuses and systems incorporating such apparatuses.

### BACKGROUND

In many patient or convalescent settings, there is a need for health care workers to dispense medicaments several times a day to many patients. Many of the medicaments are in pill form and the pills are often stored in medicine dispensing carts or trolleys. The carts and the drawers or cabinets therein are generally rectangular in shape. While such rectangular drawers or cabinets may be used to store cylindrical pill containers, storing cylindrical containers in a rectangular drawer can lead to the cylindrical containers sliding around within the drawer, such that the position of the container may change. Disorganization of such medicines then requires extra time for the health care worker to identify the correct medicine prior to dispensing it to the patient. Also, disarray of the medicines contained in a dispensing cart has the potential to be dangerous if containers are confusingly similar in shape, size, or the type of pills they contain. Also, it can be challenging to keep track of different medicines when the different containers are not organized, as the health care worker will need to identify each and every container and the amount of medicine at the beginning and the end of their rounds.

### SUMMARY

The present disclosure provides apparatuses used to hold and dispense pills or other medicaments.

In a first aspect, the disclosure provides an apparatus for containing and dispensing pills, the apparatus comprising: a shell member, which encloses a cavity in two dimensions, wherein the shell member has a height and a cross-section, and wherein the cross-section has a rectangular shape, and wherein the shell member encloses the cavity in directions perpendicular to the height, such that the cavity has a first end and a second end, which oppose each other; a bottom member, which is disposed onto the shell member, and encloses the cavity at the first end; and a top member, which is disposed onto the shell member, and encloses the cavity at the second end. In some embodiments, thereof, the apparatus is configured to fit in a rectangular drawer or cabinet found in a medicine cart.

In a second aspect, the disclosure provides a method of dispensing a pill to a subject, comprising: providing an apparatus of the first aspect or any embodiments thereof; introducing a plurality of pills to the cavity of the apparatus; removing one or more of the plurality of pills from the cavity of the apparatus; and providing the one or more of the plurality of pills to a subject.

In a third aspect, the disclosure provides a system for dispensing pills, comprising: a plurality of apparatuses of any one of the first aspect or any embodiments thereof, wherein the plurality of apparatuses are disposed in a holder in a manner to resist spatial rearrangement of the plurality of apparatuses relative to each other.

Other aspects and embodiments are set forth in the foregoing Detailed Description.

### BRIEF DESCRIPTION OF DRAWINGS

FIG. 1 shows a front perspective view of an embodiment of the apparatuses disclosed herein.

FIG. 2 shows a side view of an embodiment of the apparatuses disclosed herein.

FIGS. 3A and 3B show a top panel an embodiment of the apparatuses disclosed herein that includes a closeable orifice. FIG. 3A shows the top in place on the apparatus and FIG. 3B shows the top removed from the apparatus and having the closeable orifice in the open position.

FIG. 4 shows an embodiment of the apparatuses disclosed herein having pills contained therein.

FIG. 5 shows an embodiment of the apparatuses disclosed herein. A quarter is included in the photo for scale.

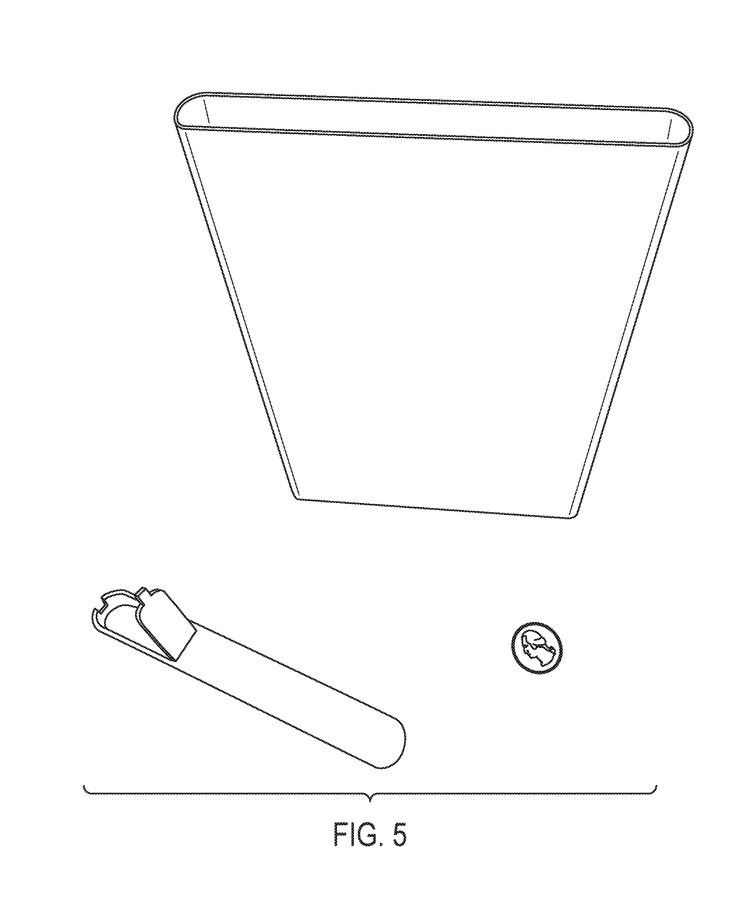

### DETAILED DESCRIPTION

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. It will be further understood that the endpoints of each of the ranges are significant both in relation to the other endpoint, and independently of the other endpoint. Thus, the endpoint of one range is combinable with the endpoint of another range. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. The nomenclatures used in connection with the laboratory procedures and techniques described herein are those well-known and commonly used in the art.

The following terms, unless otherwise indicated, shall be understood to have the following meanings:

As used herein, the terms “a”, “an”, and “the” can refer to one or more unless specifically noted otherwise.

The use of the term “or” is used to mean “and/or” unless explicitly indicated to refer to alternatives only or the alternatives are mutually exclusive, although the disclosure supports a definition that refers to only alternatives and “and/or.” As used herein “another” can mean at least a second or more.

Throughout this application, the term “about” is used to indicate that a value includes the inherent variation of error for the device, the method being employed to determine the value, or the variation that exists among samples. It is to be understood, although not always explicitly stated, that all numerical designations may be preceded by the term “about.”

### Apparatuses for Containing and Dispensing Pills

In at least one aspect, the disclosure provides an apparatus for containing and dispensing pills, the apparatus comprising: a shell member, which encloses a cavity in two dimensions, wherein the shell member has a height and a cross-section, and wherein the cross-section has a rectangular shape, and wherein the shell member encloses the cavity in directions perpendicular to the height, such that the cavity has a first end and a second end, which oppose each other; a bottom member, which is disposed onto the shell member, and encloses the cavity at the first end; and a top member, which is disposed onto the shell member, and encloses the cavity at the second end.

In some embodiments, the apparatus is a substantially rectangular pill dispenser. For example, in some embodiments, the dispenser is configured to fit within a drawer or a cabinet of a medicine cart or trolley. As used herein, the term “substantially rectangular” means that at least one surface of the apparatus is rectangular. For example, in some embodiments, the front and back surfaces (e.g., external surfaces of the shell member) of the apparatus are rectangular. In some further embodiments, the bottom and top surface (e.g., external surfaces of the bottom member and top member, respectively) of the apparatus are rectangular. As used herein, the top surface is the surface of the dispenser that is the most upper surface of the apparatus when the apparatus is positioned for storage of a medicament in a storage cart or other container. Also, the front surface is generally the surface that faces the health care worker when the apparatus is stored in a medical cart or medicine cabinet. Also, as used herein, the depth of the apparatus is the size of the dispenser along its narrowest dimension.

While the apparatus may have a generally rectangular shape, it may be shaped to facilitate use by the health care worker. In certain embodiments, the apparatus is flared in that the depth of the bottom surface is less than the depth of the top surface. In some embodiments, the sides of the dispenser may be rounded to allow the dispenser to be manufactured in a mold and or to increase the strength of the dispenser. The external surface(s) of the apparatus (e.g., at least a portion of the shell member) may include a textured surface facilitate gripping by a health care worker.

In some embodiments, it may be useful to describe the apparatus in terms of a shell member, a bottom member, and a top member, as described above. In some such embodiments, the shell member comprises a contiguous member that encloses a cavity in two dimensions, meaning that the shell member does not enclose the cavity in one dimension e.g., the dimension along the direction referred to as the “height” of the apparatus. In that sense, the shell member forms a contiguous tube with the cavity lying in the interior of the tube, with the distance from one end of the tube to the other forming the height. At any point along the height of the shell member, one can define a “cross-section,” which is a plane lying perpendicular to the axis defining the height of the shell member. In some embodiments, the cross-section has a rectangular shape, where the longer of the two dimensions forming the rectangle is defined as the “width” and the shorter of the two dimensions forming the rectangle is defined as the “depth.” Thus, the shell member encloses the cavity along the axes defining the width and the depth, while the shell member does not enclose the cavity along the axis defining the height. Thus, in terms of the shell member, this creates two open ends, which are referred to above as the first end and the second end, or the bottom end and top end, respectively.

As noted above, the apparatus generally comprises a bottom member. In some embodiments, the bottom member is disposed onto the shell member and encloses the first end. In this context, the term “disposed” does not imply any particular manufacturing process. For example, in some embodiments, the bottom member is integral with the shell member, for example, when the shell member and the bottom member are molded as a single piece. In other embodiments, the bottom member is manufactured separately from the shell member and adhered to first end of the shell member by any suitable process, such as adhesive bonding, friction fitting, and the like. In some embodiments, the bottom member is manually detachable (and reattachable) from the shell member, which, for example, can allow one to detach the bottom member to fill the cavity. The bottom member encloses the first end. Thus, in some embodiments, the bottom member has a width and a depth, referred to as the bottom width and the bottom depth.

As noted above, the apparatus also generally comprises a top member. In some embodiments, the top member is disposed onto the shell member and encloses the second end. In this context, as with the bottom member, the term “disposed” does not imply any particular manufacturing process. For example, in some embodiments, the top member is integral with the shell member, for example, when the shell member and the top member are molded as a single piece. In other embodiments, the top member is manufactured separately from the shell member and adhered to second end of the shell member by any suitable process, such as adhesive bonding, friction fitting, and the like. In some embodiments, the top member is manually detachable (and reattachable) from the shell member, which, for example, can allow one to detach the top member to fill the cavity. The top member encloses the second end. Thus, in some embodiments, the top member has a width and a depth, referred to as the top width and the top depth.

In some embodiments, the width of the cross-section can be the same at the first end as at the second end, for example, where the cross-section maintains the same width along the entire height of the shell member. In some embodiments, however, the width at the second end (i.e., the top width) is greater than the width at the first end (i.e., the bottom width). In some such embodiments, the top width is greater than the bottom width by a factor of at least 1.02, or at least 1.05, or at least 1.10, or at least 1.15, or at least 1.20, or at least 1.25, and, in some further embodiments, by a factor of no more than 2.00, or no more than 1.75, or no more than 1.60, or no more than 1.50. In some other embodiments, the bottom width is greater than the top width by a factor of at least 1.02, or at least 1.05, or at least 1.10, or at least 1.15, or at least 1.20, or at least 1.25, and, in some further embodiments, by a factor of no more than 2.00, or no more than 1.75, or no more than 1.60, or no more than 1.50. In some embodiments where the top width is different from the bottom width, the apparatus has a flared configuration in that direction along the height. In such embodiments, the flaring can assist with mechanical stability, for example, when the apparatus is removed from a holder and used by a health care worker to dispense one or more pills.

In some embodiments, the depth of the cross-section can be the same at the first end as at the second end, for example, where the cross-section maintains the same depth along the entire height of the shell member. In some embodiments, however, the depth at the second end (i.e., the top depth) is greater than the depth at the first end (i.e., the bottom depth). In some such embodiments, the top depth is greater than the bottom depth by a factor of at least 1.02, or at least 1.05, or at least 1.10, or at least 1.15, or at least 1.20, or at least 1.25, and, in some further embodiments, by a factor of no more than 2.00, or no more than 1.75, or no more than 1.60, or no more than 1.50. In some other embodiments, the bottom depth is greater than the top depth by a factor of at least 1.02, or at least 1.05, or at least 1.10, or at least 1.15, or at least 1.20, or at least 1.25, and, in some further embodiments, by a factor of no more than 2.00, or no more than 1.75, or no more than 1.60, or no more than 1.50. In some embodiments where the top depth is different from the bottom depth, the apparatus has a flared configuration in that direction along the height. In such embodiments, the flaring can assist with mechanical stability, for example, when the apparatus is removed from a holder and used by a health care worker to dispense one or more pills.

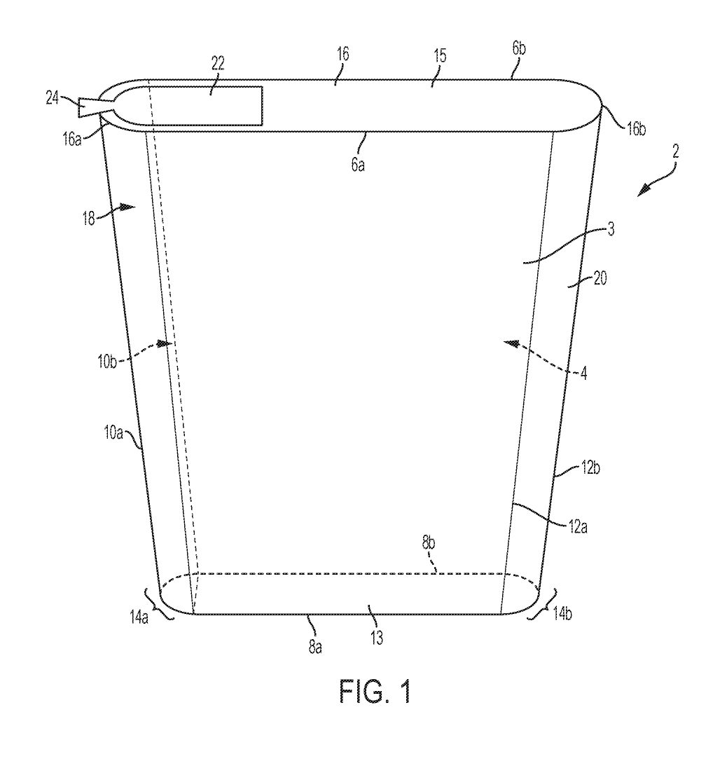

FIG. 1 shows an example of an apparatus 2 according to the present disclosure. As shown in FIG. 1, the front 3 and back 4 faces of the apparatus are rectangular shaped having parallel top edges 6a, 6b and bottom edges 8a, 8b and parallel left edges 10a, 10b and right edges 12a, 12b, respectively. Also shown in FIG. 1 is the flared shape of the apparatus, e.g., along the depth. As depicted in FIG. 1, the bottom depth 14a, 14b is less than the top depth 16a, 16b. Also, in certain embodiments, the apparatus may have convex sides 18 and 20. This is also seen as the rounded edges 16a, 16b, 14a and 14b. In some cases this may facilitate rounded pills to fit more easily in the apparatus. In embodiments where the sides are rounded, e.g., along the depth of the cross-section, the cross-section is still said to have a “rectangular” shape, so long as the angle formed by front or back surfaces (i.e., surfaces along the width of the cross-section) and an edge surface (i.e., the surface along the depth of the cross-section) is no more than 120°, or no more than 110°, or no more than 100°, or no more than 90°.

The apparatus can have any suitable size, e.g., to facilitate dispensing of a particular pill shape or size. For example, in certain embodiments, the bottom depth is about the same as the diameter of a pill to be contained in the apparatus. In such embodiments, the pills may layer within the apparatus with about one layer of pills being contained within the depth of the apparatus. Or, in some other embodiments, the apparatus may have a depth that is significantly larger than the pill diameter.

The exact size and shape of the apparatus can be optimized for the particular intended use. For example, in certain embodiments the top depth is about 1.5 times larger than the diameter of a pill to be contained in the apparatus. Or, the apparatus may not be flared at all such that the top depth is the same as the bottom surface depth. Or, the apparatus may be flared such that the wider portion of the apparatus is at the bottom of the apparatus. Such an embodiment could facilitate storing the apparatus in a standing position (since the base is wider) while still maintaining the benefits of using a rectangular apparatus. In some embodiment, the ratio of the top surface depth to the bottom surface depth may range from 0.05, 0.1, 0.5, 0.75, 1.0, 1.5, 5, 10, 15, and 20 and all values within this range of ratios (i.e., from 0.05-20).

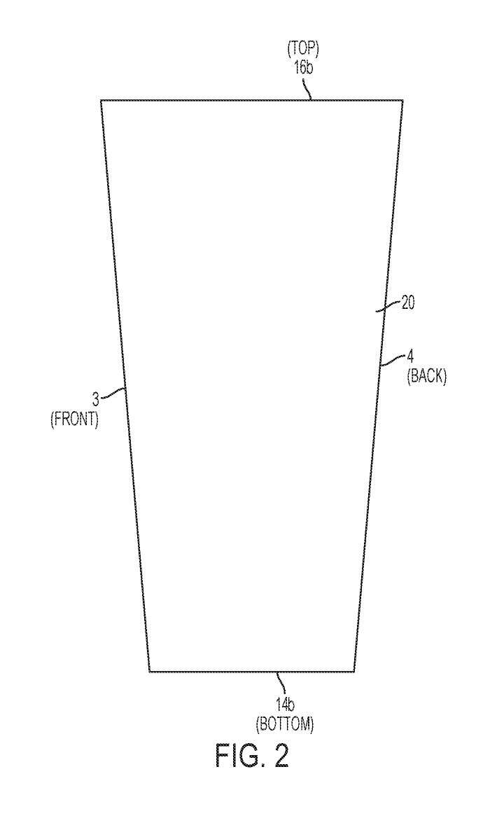

For example, in some embodiments, the bottom depth ranges from 0.2 inches to 1.0 inches, or from 0.3 inches to 0.8 inches. In some embodiments, the bottom depth is about 0.5 inches. In some further such embodiments, the top depth ranges from 0.4 inches to 2.0 inches, or from 0.5 inches to 1.5 inches. In some such embodiments, the top depth is about 0.75 inches. FIG. 2 shows a side view of the apparatus having a bottom edge 14b that has less depth than the top edge 16b.

In some embodiments embodiment, the apparatus has a size and shape configures to fit in a medical cart having holders configured to receive pills stored in flat rectangular holders (such as those disclosed herein). The size and the shape of the apparatus may depend on a variety of factors, including the size of the medication, the amount of the medication required to be dispensed, whether the apparatus may be filled with medicaments and then used over a period of several days or weeks, or whether the medicines for dispensing must be aliquoted daily, and the like. For example, in some embodiments, where, for example, the apparatus may be used to dispense vitamins and similarly sized pills, the apparatus has a height ranging from 4 inches to 18 inches, or from 6 inches to 15 inches, or from 8 inches to 10 inches. In some further such embodiments, the apparatus has a width ranging from 3 inches to 10 inches, or from 4 inches to 7 inches. Such a sized apparatus would have a volume of about 800 mL. Or other sizes (e.g., ranging from 80 mL to about 3,000 mL, or from 200 mL to 2,000 mL, may be used.

The apparatus may have a removable side/surface to facilitate putting pills in the apparatus. For example, as noted above, in some embodiments, the apparatus may comprise a removable or detachable (and reattachable) top member 15.

In some embodiments, the apparatus has an orifice (i.e., an opening) configured to aliquot out pills from the apparatus. In certain such embodiments, the top surface comprises the orifice, and the orifice is smaller in diameter than the top depth. In this way, the orifice may be used used to facilitate dispensing a single pill or two. In some such embodiments, a closeable member (e.g., lid) is disposed on the top member, and is configured to close and open the orifice. In such embodiments, the orifice is referred to as a closeable orifice, e.g., for dispensing pills contained within the pill apparatus.

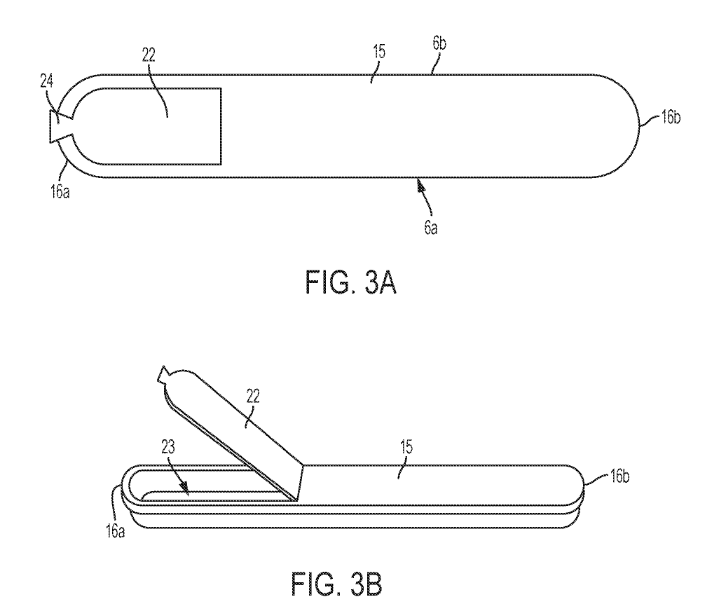

FIG. 3A shows bird's eye view of a top member of an apparatus of the present disclosure. In certain embodiments, the top member 15 may be removed by lifting the entire lid off as shown in FIG. 3B. Also, shown in FIG. 3A and FIG. 3B is a lid 22 that shuts to close the closeable orifice. In certain embodiments, the lid 22 for the closeable orifice 23 includes a tab 24 or some other such element to facilitate opening and closing of the lid by a user (e.g., health care worker).

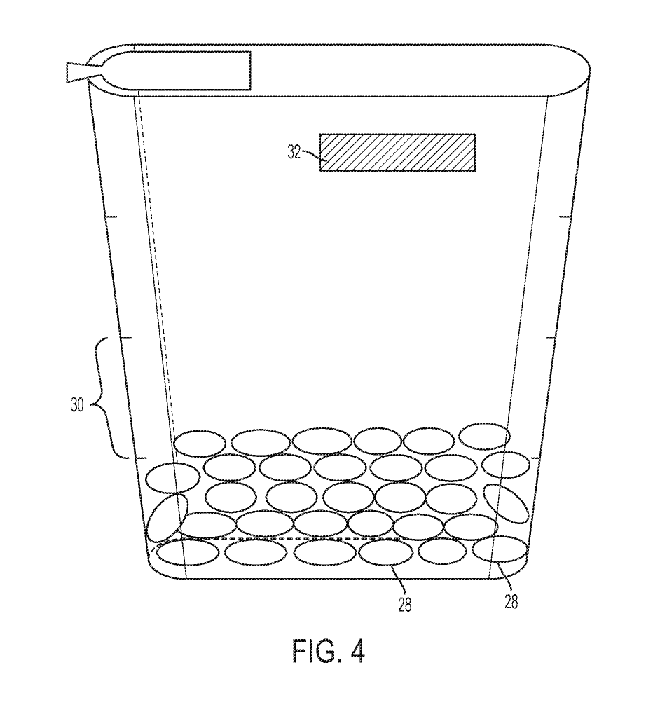

FIG. 4 shows an embodiment of an apparatus of the present disclosure having pills contained therein. In some embodiments, the apparatus may comprise markings 30 to indicate the approximate volume or number of pills contained within it. In some other embodiments, the apparatus comprises a marking (e.g., a bar code) or coloration 32 to indicate the type (e.g., composition and dosage strength) of pills contained within the apparatus. Such markings or coloration can be on the top portion, the bottom portion, the shell portion, or any combination thereof. For example, in some embodiments, the apparatus may be a certain color, or bear a label (e.g., “Pills XYZ”) or a bar code to indicate the type (e.g., composition and dosage strength) of medicament or pills contained in the apparatus. Also, in some embodiments, and as shown in FIG. 4, in some cases the apparatus (e.g., at least a portion of the shell member) is substantially transparent (e.g., translucent) so that a user can see the approximate volume or number of pills contained within the apparatus.

The apparatus disclosed herein can be made of any material suitable for use in a medical setting. Also, the material used may be one that is sturdy, such that if the apparatus is dropped it will not break. Also, the apparatus may be made of a material that is transparent or at least translucent such that the pills contained therein can be seen by a health care worker. As noted above, the apparatus may be colored, or have some type of markings to indicate the quantity of medicine contained therein and the type (e.g., composition and dosage strength) of pills.

In certain embodiments, at least a portion of the apparatus may be formulated in a mold, e.g., via injection molding. Thus, materials used to make the apparatus include, but are not limited to, metal, synthetic polymers, ceramics, thermoplastic and polymeric material or their composites. For example, moldable plastic appropriate for type of production (e.g., polyethylene, polypropylene) may be used. Materials suitable for manufacturing apparatuses disclosed herein include, but are not limited to, stainless steel alloys, commercially pure titanium, titanium alloys, cobalt-chrome alloys, stainless steel alloys, ceramics and composites thereof such as calcium phosphate, thermoplastics such as polyaryletherketone (PAEK) including polyetheretherketone (PEEK), polyetherketoneketone (PEKK) and polyetherketone (PEK), carbon-PEEK composites, PEEK-BaSO₄ polymeric rubbers, polyethylene terephthalate (PET), fabric, silicone, polyurethane, silicone-polyurethane copolymers based materials, polymeric rubbers, polyolefin rubbers, semi-rigid and rigid materials, thermoplastic elastomers, thermoset elastomers, elastomeric composites, rigid polymers including polyphenylene, polyamide, polyimide, polyetherimide, polyethylene, epoxy, polyacrylate and composites of metals and calcium-based ceramics, composites of PEEK and calcium based ceramics, and combinations of the above materials.

### Methods of Use

In at least another aspect, the disclosure provides methods of using such apparatuses. For example, in some embodiments, the method comprises providing an apparatus as disclosed herein comprising a plurality of pills and accessing individual pills from the apparatus and providing such pills to a subject.

In a related aspect, the disclosure provides a method of dispensing a pill to a subject, comprising: providing an apparatus of the foregoing aspects or any embodiments thereof; introducing a plurality of pills to the cavity of the apparatus; removing one or more of the plurality of pills from the cavity of the apparatus; and providing the one or more of the plurality of pills to a subject.

In some embodiments, the plurality of pills in the cavity are of the same type (e.g., same composition and dosage strength). In some further such embodiments, one or more of the top member, the bottom member, or the shell member comprise coloration or one or more markings (e.g., bar codes) indicating the type of the pills.

In some further embodiments, the methods disclosed herein can be used in combination with information about the subject, such as information about whether a subject is eligible to be provided one or more pills of a certain type (e.g., composition and dosage strength). Thus, in some embodiments, the method further comprises detecting the color or one or more markings and determining, based on the detected information, that the subject is eligible to be provided one or more of the plurality of pills of a certain type (e.g., composition and dosage strength). The detecting and determining can be carried out by any suitable means. For example, it can be determined by visually inspecting the coloration or one or more markings and reviewing information concerning the subject. But, in other embodiments, it can comprise electronically scanning the coloration or one or more markings and electronically scanning information concerning the subject, such as a bar code or other such information indicative of the identity of the subject. This would allow for convenience in administering pills in a health care setting, while also reducing the risk of errors in providing pills to subjects. In some embodiments, such methods could be integrated with record-keeping systems, such that an electronic record is made that records that the subject was provided a certain type (e.g., composition and dosage strength) of pill.

### Systems Comprising a Plurality of Apparatuses

In at least another aspect, the disclosure provides a system for dispensing pills, comprising: a plurality of apparatuses of any one of the first aspect or any embodiments thereof, wherein the plurality of apparatuses are disposed in a holder in a manner to resist spatial rearrangement of the plurality of apparatuses relative to each other. Any suitable holder can be used, including, but not limited to, a drawer, a cabinet, a shelf, or a receptacle (e.g., a bin). In some such embodiments, the holder comprises a plurality of slots, each of which is configured to receive one of the plurality of apparatuses.

It will be understood that various modifications may be made to the aspects and embodiments disclosed herein. Therefore, the above description should not be construed as limiting, but merely as exemplification of the various embodiments. Those skilled in the art will envision other modifications within the scope and spirit of the claims appended hereto.

1. An apparatus for containing and dispensing pills, the apparatus comprising:
a shell member, which encloses a cavity in two dimensions, wherein the shell member has a height and a cross-section, and wherein the cross-section has a rectangular shape, and wherein the shell member encloses the cavity in directions perpendicular to the height, such that the cavity has a first end and a second end, which oppose each other;
a bottom member, which is disposed onto the shell member, and encloses the cavity at the first end; and
a top member, which is disposed onto the shell member, and encloses the cavity at the second end.

2. The apparatus of claim 1, wherein the bottom member has a rectangular shape, whose dimensions are defined by a bottom width and a bottom depth.

3. The apparatus of claim 2, wherein the top member has a rectangular shape, whose dimensions defined by a top width and a top depth.

4. The apparatus of claim 3, wherein the top width is the same as the bottom width.

5. The apparatus of claim 3, wherein the top depth is the same as the bottom depth.

6. The apparatus of claim 3, wherein the top depth is less than the bottom depth.

7. The apparatus of claim 3, wherein the top depth is greater than the bottom depth.

8. The apparatus of claim 3, wherein the bottom depth ranges from 0.2 inches to 1.0 inches.

9. The apparatus of claim 3, wherein the top depth ranges from 0.5 inches to 2.0 inches.

10. The apparatus of claim 3, wherein the top width and the bottom width range from 3 inches to 10 inches.

11. The apparatus of claim 1, wherein the top width and the height ranges from 4 inches to 18 inches.

12. The apparatus of claim 1, wherein the top member is removable.

13. The apparatus of claim 1, wherein the top member comprises a closeable orifice, which is configured to dispense one or more pills from the cavity.

14. The apparatus of claim 1, wherein the cavity has a volume ranging from 200 mL to 2,000 mL.

15. The apparatus of claim 1, wherein one or more of the shell member, the top member, or the bottom member comprise coloration or one or more markings.

16. The apparatus of claim 1, wherein at least a portion of the shell member is translucent, so as to indicate the volume or number of pills in the cavity.

17. The apparatus of claim 1, wherein at least a portion of an external surface of the shell member comprises a textured surface.

18. The apparatus of claim 1, wherein the cavity comprises a plurality of pills of the same type, and wherein one or more of the shell member, the top member, or the bottom member comprise coloration or one or more markings indicating the type of the plurality of pills.

19. The apparatus of claim 1, wherein the shell member comprises a plastic material and is formed via injection molding.

20. A method of dispensing a pill to a subject, comprising:
providing an apparatus of claim 1;
introducing a plurality of pills to the cavity of the apparatus;
removing one or more of the plurality of pills from the cavity of the apparatus via the closeable orifice; and
providing the one or more of the plurality of pills to a subject.

21-25. (canceled)
